(19) United States
(12) Patent Application Publication
(10) Pub. No.: US 2018/0150226 A1
(43) Pub. Date: May 31, 2018

(54) METHOD AND APPARATUS FOR MANAGEMENT OF DATA

(71) Applicant: FUJITSU LIMITED, Kawasaki-shi (JP)

(72) Inventors: Hitoshi UENO, Kawasaki (JP); Kenichi Abiru, Sagamihara (JP)

(73) Assignee: FUJITSU LIMITED, Kawasaki-shi (JP)

(21) Appl. No.: 15/795,336

(22) Filed: Oct. 27, 2017

(30) Foreign Application Priority Data
Nov. 30, 2016 (JP) 2016-232134

(51) Int. Cl. G06F 3/06

(52) U.S. Cl. CPC G06F 3/0604; G06F 3/0683; G06F 3/0638

(57) ABSTRACT

A disclosed data management method includes: identifying, for each key included in a plurality of sets each of which includes a key and a value, a frequency that the key was used for search, when the plurality of sets is to be added to one of a plurality of storage units that dispersedly store sets each of which includes a key and a value; weighting each key included in the plurality of sets by the frequency identified for the key to calculate, for each of the plurality of storage units, an inclusion degree for keys included in the plurality of sets; and selecting a storage unit to which the plurality of sets is to be added based on the calculated inclusion rates.

### CROSS-REFERENCE TO RELATED APPLICATIONS

This application is based upon and claims the benefit of priority of the prior Japanese Patent Application No. 2016-232134, filed on Nov. 30, 2016, the entire contents of which are incorporated herein by reference.

### FIELD

This invention relates to a technique for managing data dispersedly.

### BACKGROUND

In a system in which sets of values associated with keys are dispersedly stored in plural storage units, storing values relating to the same type of keys in the same storage unit makes it efficient to search using keys.

However, when registering data that includes plural keys, processing to allocate and arrange the data according to the plural keys is complicated. Namely, considering a load of processing to register, it is favorable to collectively allocate data that includes plural keys to any one of management apparatuses. And there is no technique for arranging data that includes plural keys so as to improve efficiency of search.

Patent Document 1: International Publication Pamphlet No. WO 2013/061680

Patent Document 2: Japanese Laid-open Patent Publication No. 2013-156960

SUMMARY

A data management method relating to one aspect includes: identifying, for each key included in a plurality of sets each of which includes a key and a value, a frequency that the key was used for search, when the plurality of sets is to be added to one of a plurality of storage units that dispersedly store sets each of which includes a key and a value; weighting each key included in the plurality of sets by the frequency identified for the key to calculate, for each of the plurality of storage units, an inclusion degree for keys included in the plurality of sets; and selecting a storage unit to which the plurality of sets is to be added based on the calculated inclusion rates.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an aspect of generation of approach records;

FIG. 2 is a diagram depicting an example of a network configuration;

FIG. 3 is a diagram depicting an example of a hardware configuration of a management system;

FIG. 4 is a diagram depicting a sequence of a registration phase;

FIG. 5 is a diagram depicting an example of collection data;

FIG. 6 is a diagram depicting an example of accumulation data;

FIG. 7 is a diagram depicting an example of notification data;

FIG. 8 is a diagram depicting an example of a management table;

FIG. 9 is a diagram depicting an example of a bloom filter;

FIG. 10 is a diagram depicting an example of abloom filter;

FIG. 11 is a diagram depicting an example of transmission of notification data;

FIG. 12 is a diagram depicting a sequence of the registration phase;

FIG. 13 is a diagram depicting a sequence of a search phase;

FIG. 14 is a diagram depicting an example of a usage frequency table;

FIG. 15 is a diagram depicting an example of calculation of a total point;

FIG. 16 is a diagram depicting an example of a module configuration of a management node;

FIG. 17 is a diagram depicting a flow for primary registration processing (A);

FIG. 18 is a diagram depicting a flow for bloom filter determination processing (A);

FIG. 19 is a diagram depicting a flow for the primary registration processing (A);

FIG. 20 is a diagram depicting a flow for bloom filter update processing (A);

FIG. 21 is a diagram depicting a flow for secondary registration processing;

FIG. 22 is a diagram depicting an example of a module configuration of a search apparatus;

FIG. 23 is a diagram depicting a flow for search processing (A);

FIG. 24 is a diagram depicting a flow for the search processing (A);

FIG. 25 is a diagram depicting an example of a bloom filter relating to a second embodiment;

FIG. 26 is a diagram depicting a flow for primary registration processing (B);

FIG. 27 is a diagram depicting a flow for point addition processing;

FIG. 28 is a diagram depicting a flow for the primary registration processing (B);

FIG. 29 is a diagram depicting a flow for bloom filter update processing (B);

FIG. 30 is a diagram depicting a flow for search processing (B);

FIG. 31 is a diagram depicting a flow for bloom filter determination processing (B); and

FIG. 32 is a functional block diagram of a computer.

### DESCRIPTION OF EMBODIMENTS

### Embodiment 1

A watch over service to which a data management method relating to embodiments is applied will be explained. The watch over service is intended to watch over a school child by local residents. When a user who is a local resident approaches a school child in a town, a record is generated in a user terminal.

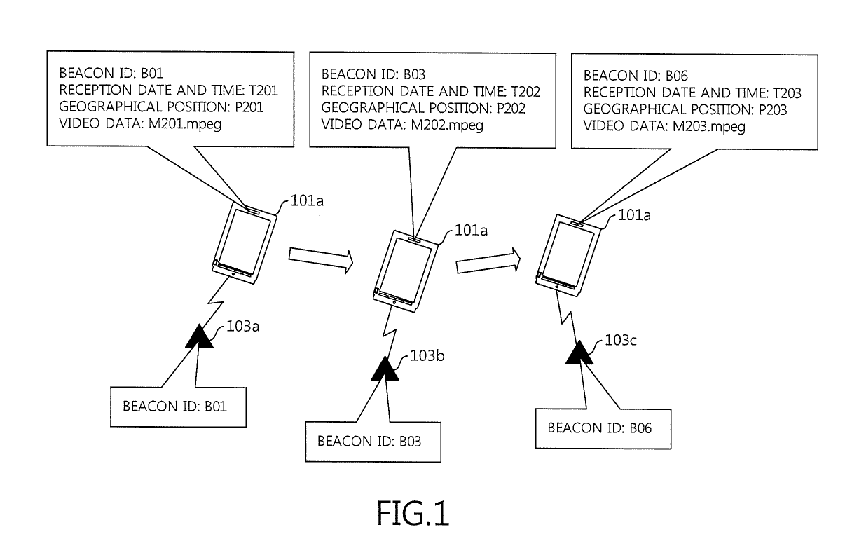

FIG. 1 is a diagram depicting an aspect of generation of approach records in a user terminal 101. A user that watches over a school child has a user terminal 101a. Each school child has a beacon transmitter 103. The user terminal 101a is, for example, a smartphone. The user terminal 101a has a communication device for a short-range wireless system (for example, BLE (Bluetooth (registered trademark) Low Energy) communication system), a clock, a GPS (Global Positioning System) device, and a camera. The beacon transmitter 103 transmits a beacon signal by the short-range wireless system.

When a distance between a user and a school child who has the beacon transmitter 103a becomes shorter, the user terminal 101a receives a beacon signal transmitted by the beacon transmitter 103a. The user terminal 101a extracts a beacon ID from the beacon signal. The beacon ID included in the beacon signal transmitted by the beacon transmitter 103a is B01. The user terminal 101a identifies a date and time at which the beacon signal was received using a clock unit (hereinafter, referred to as reception date and time). The user terminal 101a identifies a geographical position where the beacon signal was received using the GPS device. Further, the user terminal 101a urges the user to shoot a video and makes a video according to an operation of the user. The user terminal 101a stores the beacon ID, the reception date and time, the geographical position, and the video data in association with each other. The data stored at this time is hereinafter referred to as an approach record. At this phase, an approach record that includes a beacon ID B01, a reception date and time T201, a geographical position P201, and video data M201.mpeg is generated.

After that, when a distance between the user and a school child who has a beacon transmitter 103b becomes shorter, the user terminal 101a receives a beacon signal transmitted by the beacon transmitter 103b. The user terminal 101a extracts a beacon ID B03 from the beacon signal. At this phase, an approach record that includes the beacon ID B03, a reception date and time T202, a geographical position P202, and video data M202.mpeg is generated.

Furthermore, when a distance between the user and a school child who has a beacon transmitter 103c becomes shorter, the user terminal 101a receives a beacon signal transmitted by the beacon transmitter 103c. The user terminal 101a extracts a beacon ID B06 from the beacon signal. At this stage, an approach record that includes the beacon ID B06, a reception date and time T203, a geographical position P203, and video data M203.mpeg is generated.

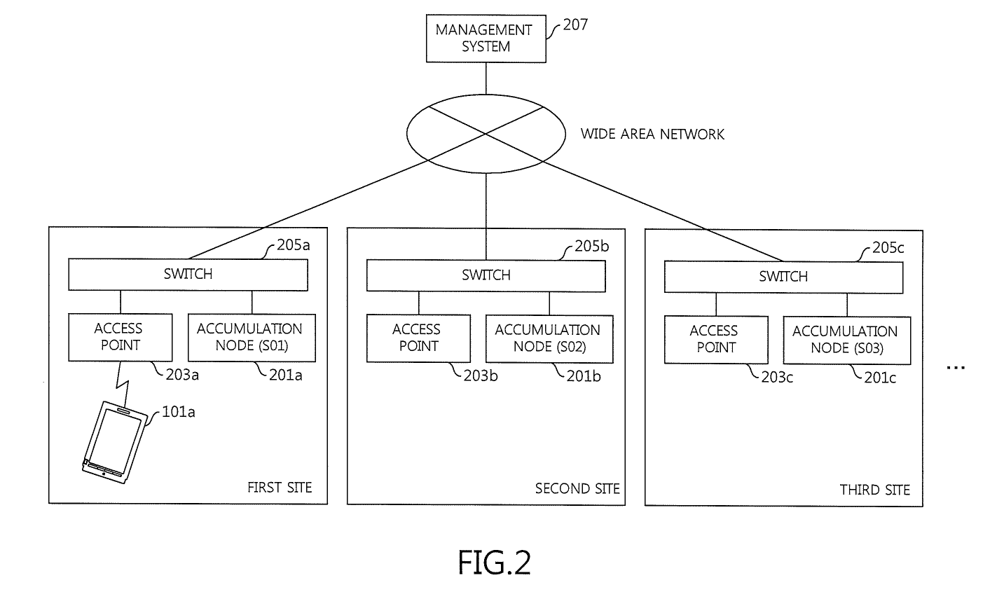

After that, approach records generated in the user terminal 101 are gathered to a device installed at a site of the town. FIG. 2 illustrates an example of a network configuration. In this example, it is assumed that three sites are set. In a system at each site, an accumulation node 201 and an access point 203 are connected to a switch 205. The access point 203 communicates with the user terminal 101 via a wireless LAN (Local Area Network). The accumulation node 201 accumulates approach records collected from the user terminal 101.

Moreover, the system at each site is connected to a management system 207 via a wide area network. The wide area network is, for example, a network within a company or the Internet.

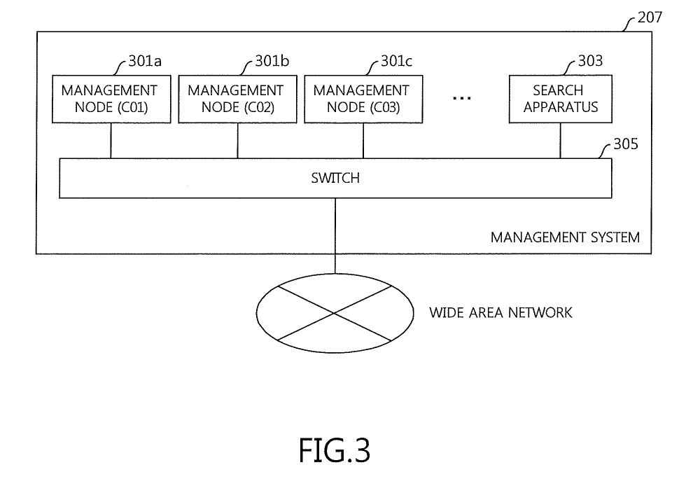

FIG. 3 illustrates an example of a hardware configuration of the management system 207. Plural management nodes 301a to 301c and the like and a search apparatus 303 are connected to a switch 305 in the management system 207. The plural management nodes 301a to 301c and the like manage locations where approach records are accumulated, in other words, accumulation node IDs. Specifically, the plural management nodes 301a to 301c dispersedly have sets of a beacon ID and an accumulation node ID included in approach records. In this way, having data dispersedly makes it easy to deal with cases where many approach records are gathered.

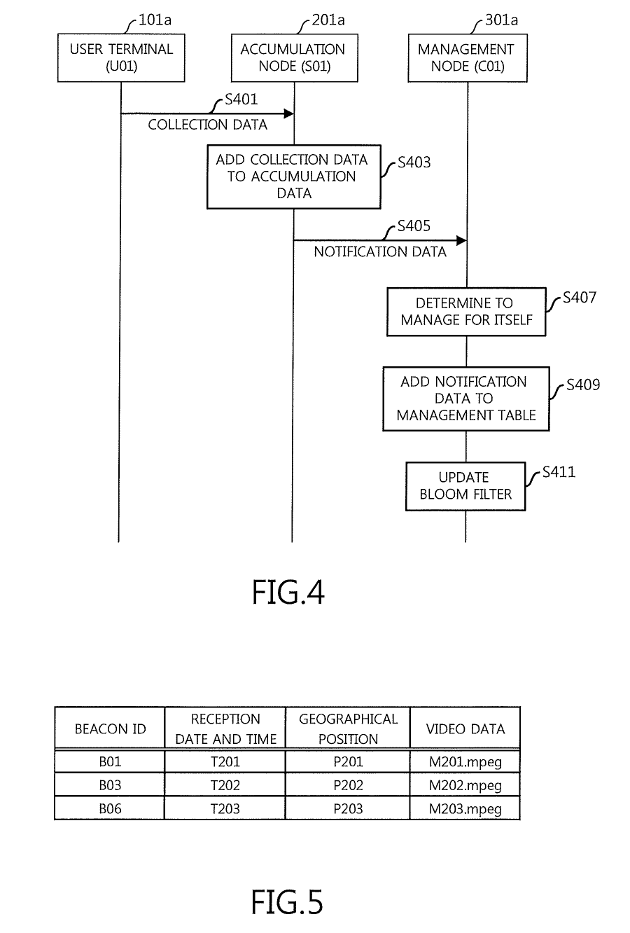

Next, a registration phase in which an approach record is added will be explained. FIG. 4 illustrates a sequence of the registration phase. When the user terminal 101a and the accumulation node 201a are connected through the access point 203a, the user terminal 101a transmits collection data to the accumulation node 201a (S401).

FIG. 5 illustrates an example of the collection data. The collection data is a set of approach records. The collection data illustrated in FIG. 5 corresponds to an aggregation of the three approach records illustrated in FIG. 1. An approach record has a field in which a beacon ID is stored, a field in which a reception date and time is stored, a field in which a geographical position is stored, and a field in which video data is stored.

Returning to the explanation of FIG. 4, the accumulation node 201a adds the received collection data to accumulation data that the accumulation node 201a has (S403).

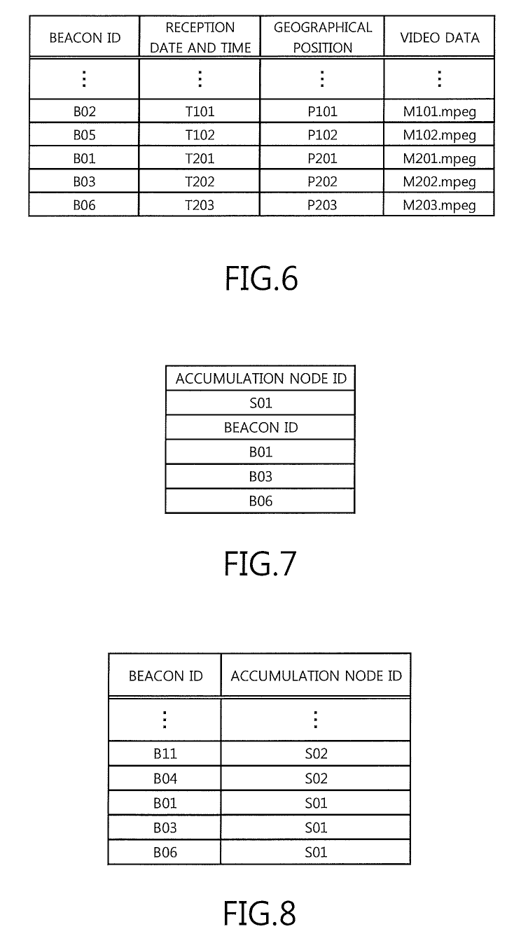

FIG. 6 illustrates an example of the accumulation data. In the accumulation data, approach records included in the received collection data is accumulated. The illustrated accumulation data represents a state in which the approach records of the collection data illustrated in FIG. 5 is added. The third record to the fifth record are the same as the approach records of the collection data illustrated in FIG. 5.

Returning to the explanation of FIG. 4, the accumulation node 201a transmits notification data related for a beacon ID included in the added collection data to the management node 301a (S405).

FIG. 7 illustrates an example of the notification data. In a header of the notification data, an ID of the accumulation node 201 to which an approach record is added is set. In a record of the notification data, a beacon ID included in the added approach records is set. An example of this notification data represents that approach records including the beacon IDs B01, B03 and B06 has been added to the accumulation node 201 identified by the ID S01.

Returning to the explanation of FIG. 4, the management node 301a determines whether or not the management node 301a manages the content of notification data by itself when receiving the notification data. Here, it is assumed that the management node 301a has determined that the management node 301a manages by itself (S407). A determination method at this time will be explained later.

In the case where the management node 301a manages the content of the notification data by itself, the management node 301a adds the content of the notification data to a management table that the management node 301a manages (S409).

FIG. 8 illustrates an example of the management table. A record of the management table has a field for storing a beacon ID and a field for storing an accumulation node ID. The beacon ID stored in this record is a beacon ID set in the notification data. Similarly, the accumulation node ID is an accumulation node ID set in the notification data. The third record in this example represents that an approach record that includes the beacon ID B01 is stored in the accumulation node 201 identified by the ID S01.

Returning to the explanation of FIG. 4, the management node 301a updates a bloom filter corresponding to the management table that the management node 301a has (S411).

The bloom filter is generally used to determine whether or not a key is included in a set. A beacon ID in the watch over service corresponds to a key. Similarly, the management table corresponds to a set. The bloom filter in this embodiment is the same as that of the conventional techniques.

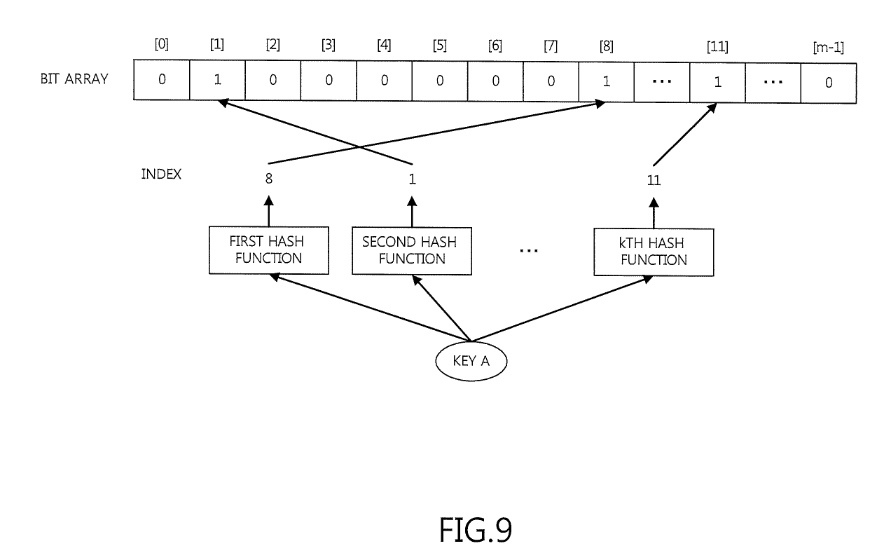

FIG. 9 illustrates an example of a bloom filter. The bloom filter is data in an array format. In this example, an array element is 1 bit and the number of array elements is m. Bits are identified by indices. In this example, since the number of arrays is m, the indices are natural numbers from 0 to m−1. In an initial state, 0 is set for each bit.

In order to use the bloom filter, k hash functions are prepared. Each hash function converts a key to an index of 0 to m−1. In other words, by inputting a key to each hash function, k indices are obtained. When adding a new key to a set, a bit identified by the index is changed to 1 if the bit is 0. A bit identified by the index is not changed when the bit is already 1.

FIG. 9 illustrates an aspect of update of the bloom filter in a case where a key A is added to the set first. The first hash function to which the key A is inputted outputs an index value 8. Then, the bit [8] of the bloom filter is changed to 1. The second hash function to which the key A is inputted outputs an index value 1. Then, the bit [1] of the bloom filter is changed to 1. The kth hash function to which the key A is inputted outputs an index value 11. Then, the bit [11] of the bloom filter is changed to 1. The same applies to the third hash function to the (k−1)th hash function.

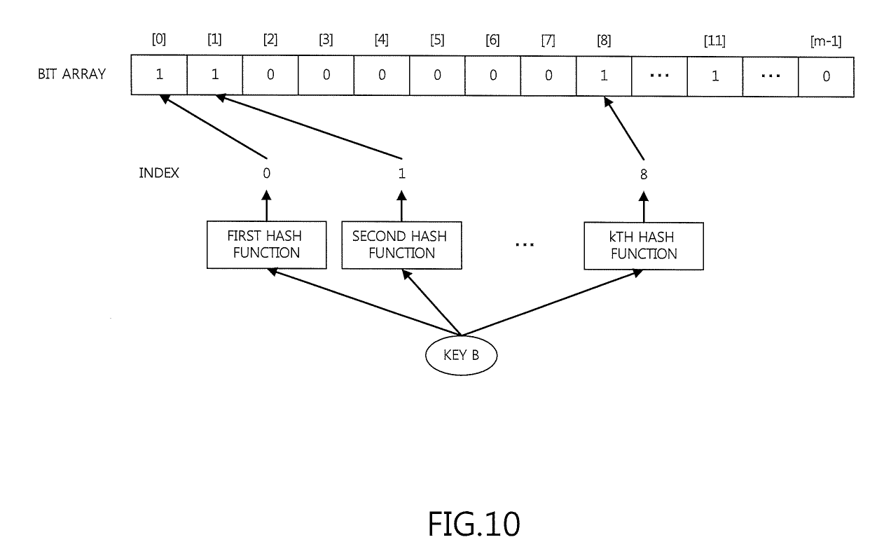

Next, FIG. 10 illustrates an aspect of update of the bloom filter in a case where a key B is added to the set. The first hash function to which the key B is inputted outputs an index value 0. Then, the bit [0] of the bloom filter is changed to 1. The second hash function to which the key B is inputted outputs an index value 1. However, since the bit [1] of the bloom filter is already 1, it is not changed. The kth hash function that to which the key B is inputted outputs an index value 8. Moreover, since the bit [8] of the bloom filter is already 1, it is not changed. The same applies to the third hash function to the (k−1)th hash function.

In this way, the fact that a key has been added to a set is recorded by mapping the key to k bits. On the other hand, when determining whether a certain key is included in a set, it is determined whether or not all bits identified by k indices converted from the key are all 1 as described above. Then, when all the bits identified by k indices are 1, it is determined that the key is included in the set. On the other hand, when at least one of the bits identified by k indices is 0, it is determined that the key is not included in the set. The explanation of the bloom filter ends here.

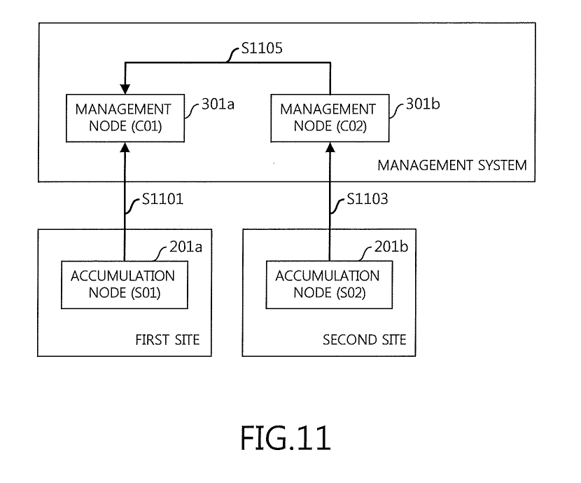

An explanation for transfer of the notification data will be added. FIG. 11 illustrates an example of transmission of the notification data. In the aforementioned example, the accumulation node 201a transmits the notification data to the management node 301a (S1101), and the management node 301a that has received the notification data manages the content of the notification data. However, the management node 301 itself that has received the notification data from the accumulation node 201 does not always manage the content of the notification data. There is a case where the management node 301 that has received the notification data determines to let another management node 301 manage the content of the notification data. As illustrated in the figure, when the accumulation node 201b transmits the notification data to the management node 301b (S1103) and the management node 301b that received the notification data determines to let the management node 301a manage the content of the notification data, the notification data is transferred to the management node 301a (S1105).

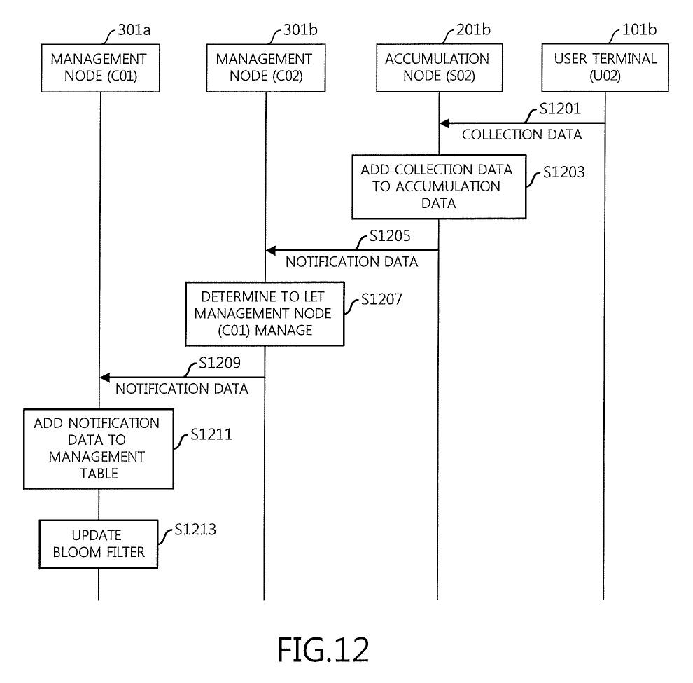

FIG. 12 illustrates a sequence in the case where the management node 301b transfers the notification data to the management node 301a in the registration phase in this way. When the user terminal 101b and the accumulation node 201b are connected, the user terminal 101b transmits collection data to the accumulation node 201b (S1201).

The accumulation node 201b adds the received collection data to accumulation data that the accumulation node 201b has (S1203). Then, the accumulation node 201b transmits notification data concerning a beacon ID included in the added collection data to the management node 301b (S1205).

When receiving the notification data, the management node 301b determines to let the management node 301a manage the content of the notification data (S1207). Then, the management node 301b transfers the notification data received from the accumulation node 201b to the management node 301a (S1209).

When the management node 301a receives the notification data transferred from the management node 301b, the management node 301a adds the notification data to the management table that the management node 301a has (S1211). Then, the management node 301a updates the bloom filter corresponding to the management table that the management node 301a has (S1213). The explanation for the overview of the registration phase ends here.

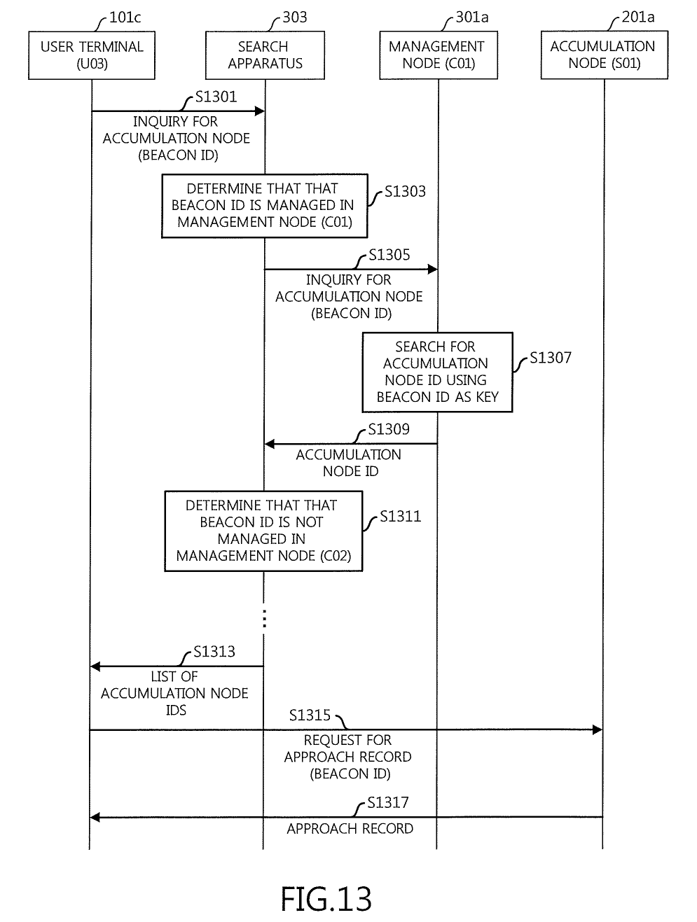

Next, with reference to FIG. 13, a sequence of a search phase for a user who is a guardian of a school child to obtain approach records will be explained. An inquiry for the accumulation node 201 is sent from the user terminal 101c of the user that attempts to obtain approach records to the search apparatus 303 (S1301). This inquiry includes a beacon ID for designating approach records.

The search apparatus 303 that received the inquiry for the accumulation node 201 determines, for each management node 301, whether or not the beacon ID is managed in the management node 301 by using the bloom filter. In this example, it is assumed that the search apparatus 303 first determines that the beacon ID is managed by the management node 301a (C01) (S1303).

The search apparatus 303 transmits an inquiry for the accumulation node 201 to the management node 301a that manages the designated beacon ID (S1305). The inquiry for the accumulation node 201 contains the designated beacon ID. In this example, the search apparatus 303 first transmits an inquiry for the accumulation node 201 to the management node 301a.

The management node 301a that received the inquiry for the accumulation node 201 searches for an accumulation node ID by using the beacon ID included in the inquiry as a key in the management table that the management node 301a has (S1307). Then, the management node 301a transmits the detected accumulation node ID back to the search apparatus 303 (S1309).

Assume that the search apparatus 303 next determines that the beacon ID is not managed in the management node 301b (C02) (S1311). In this case, the inquiry for the accumulation node 201 is not transmitted to the management node 301b. The same processing is also performed for the remaining management nodes 301.

When completing the processing relating to each management node 301, the search apparatus 303 transmits accumulation node IDs received up to then as a list to the user terminal 101c (S1313).

By obtaining this list, the user knows which accumulation node 201 has approach records relating to the beacon ID designated by the user. In this example, it is assumed that S01, which is an ID of the accumulation node 201a, is included in this list. The user terminal 101c transmits a request for approach records to the accumulation node 201a (S1315). Assume that the request for approach records includes the designated beacon ID.

When receiving the request for approach records, the accumulation node 201a extracts approach records that include the designated beacon ID from the accumulation data that the accumulation node 201a has. Then, the extracted approach records are transmitted back to the user terminal 101c (S1317).

When plural accumulation node IDs are included in the aforementioned list, the user terminal 101c transmits a request for approach records to other accumulation node 201. The user terminal 101c obtains approach records furthermore. In this way, the user terminal 101c collects approach records that include a predetermined beacon ID.

Here, a method for determining the management node 301 to which the notification data is added in this embodiment will be explained. The management node 301 identifies a frequency (hereinafter, referred to as a usage frequency) that the same beacon ID as the beacon ID included in the notification data was used for searching accumulation node IDs. The usage frequency is counted using a usage frequency table.

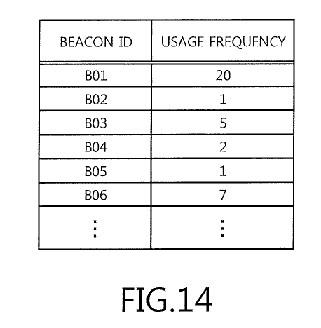

FIG. 14 illustrates an example of the usage frequency table. The usage frequency table in this example has a record (hereinafter, referred to as a usage frequency record) that corresponds to a beacon ID. The usage frequency record has a field in which the beacon ID is stored and a field in which the usage frequency is stored.

The usage frequency is a frequency that the beacon ID was used as a search key. The illustrated first record represents that search using the beacon ID B01 as a search key has been performed twenty times.

In this example, the search apparatus 303 has the usage frequency table. However, another apparatus may have the usage frequency table.

Each beacon ID included in notification data is weighted according to a usage frequency managed in this way. The management node 301 reflects weights to calculate an inclusion degree of the beacon ID included in the notification data, for each of the plural management nodes 301. The inclusion degree is calculated as a total point described below.

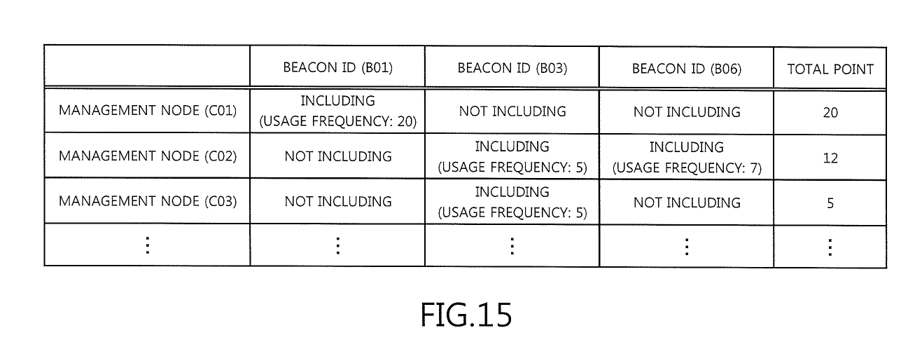

With reference to FIG. 15, a procedure for calculating the total point will be explained. In this example, it is assumed that notification data includes three beacon IDs (B01, B03 and B06). The total point is obtained by adding up usage frequencies of beacon IDs included in the management table of the management node 301.

For example, the management table in the management node 301a (C01) includes the beacon ID B01, but does not include the beacon ID B03 and the beacon ID B06. Since the usage frequency of the beacon ID B01 is 20, the total point is 20.

The management table in the management node 301b (C02) does not include the beacon ID B01 but includes the beacon ID B03 and the beacon ID B06. The usage frequency of the beacon ID B03 is 5, and the usage frequency of the beacon ID B06 is 7. Therefore, the total point is 12.

The management table in the management node 301c (C03) includes the beacon of B03, but does not include the beacon ID B01 and the beacon ID B06. Since the usage frequency in the beacon ID B03 is 5, the total point is 5.

The one that has a larger total point calculated in this way, in other words, the management node 301 that has a higher inclusion degree is selected as the management node 301 to which the notification data is added. The explanation of the overview of this embodiment ends here.

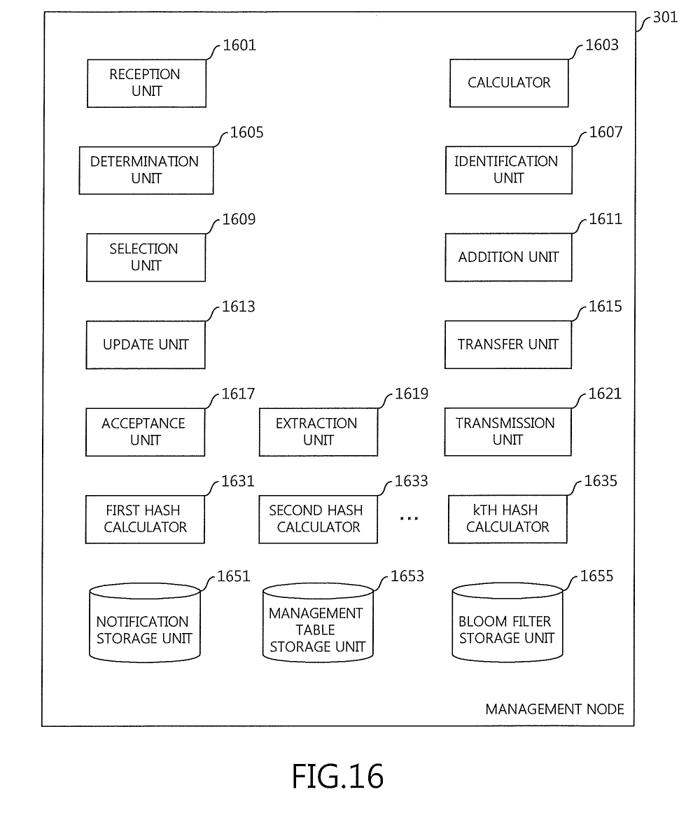

Next, operation of the management node 301 will be explained. FIG. 16 illustrates an example of a module configuration of the management node 301. The management node 301 has a reception unit 1601, a calculator 1603, a determination unit 1605, an identification unit 1607, a selection unit 1609, an addition unit 1611, an update unit 1613, a transfer unit 1615, an acceptance unit 1617, an extraction unit 1619, and a transmission unit 1621.

The reception unit 1601 receives plural types of data. The calculator 1603 calculates a total point for each management node 301. The total point in this example is an internal parameter. The determination unit 1605 executes bloom filter determination processing. The identification unit 1607 identifies a usage frequency of a beacon ID in the usage frequency table. The selection unit 1609 selects the management node 301 to which the notification data is added. The addition unit 1611 adds the content of the notification data to the own management table. The update unit 1613 executes bloom filter update processing. The transfer unit 1615 transfers the notification data to another management node 301. The acceptance unit 1617 accepts the notification data transmitted from another management node 301. The extraction unit 1619 extracts an accumulation node ID that corresponds to a beacon ID from the management table. The transmission unit 1621 transmits plural types of data.

The management node 301 has hash calculators that perform several calculations that correspond to the first hash function to the kth hash function. A first hash calculator 1631 performs calculation that corresponds to the first hash function. A second hash calculator 1633 performs calculation that corresponds to the second hash function. A kth hash calculator 1635 performs calculation that corresponds to the kth hash function. The third to (k−1)th hash calculators are not illustrated.

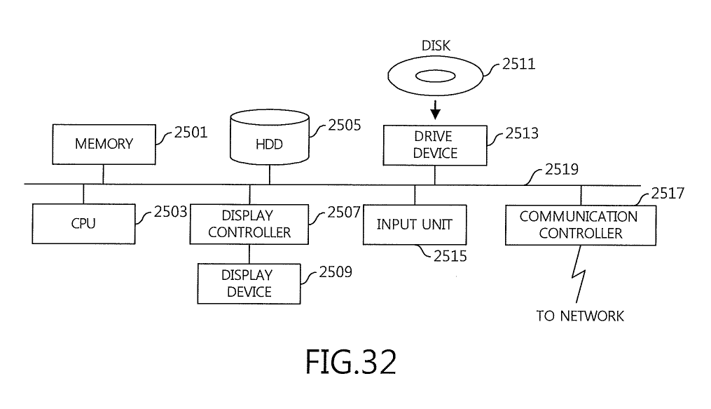

The reception unit 1601, the calculator 1603, the determination unit 1605, the identification unit 1607, the selection unit 1609, the addition unit 1611, the update unit 1613, the transfer unit 1615, the acceptance unit 1617, the extraction unit 1619, the transmission unit 1621 and each hash calculator are realized by using hardware resources (for example, FIG. 32) and a program that causes the processor to execute processing described below.

Moreover, the management node 301 has a notification storage unit 1651, a management table storage unit 1653, and a bloom filter storage unit 1655.

The notification storage unit 1651 stores the received notification data. The management table storage unit 1653 stores the management table. The bloom filter storage unit 1655 stores a bloom filter.

The notification storage unit 1651, the management table storage unit 1653, and the bloom filter storage unit 1655 described above are realized by using hardware resources (for example, FIG. 32).

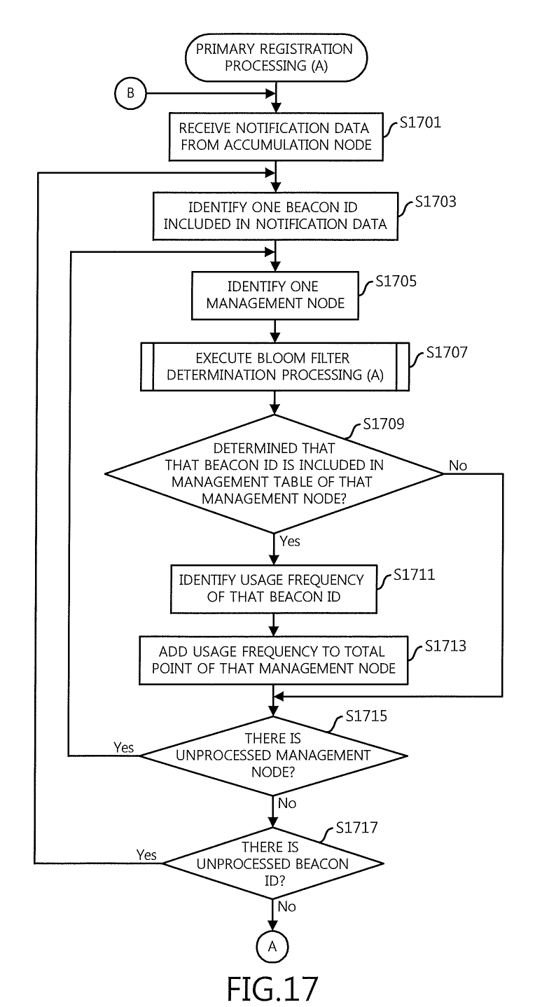

Next, processing in the management node 301 will be explained. First, processing in a case where the notification data is received from the accumulation node 201 (hereinafter referred to as primary registration processing) will be explained. The management node 301 in this embodiment executes the primary registration processing (A). FIG. 17 illustrates a flow for the primary registration processing (A).

When the reception unit 1601 receives notification data from the accumulation node 201 (S1701), the management node 301 performs processing of S1703 and subsequent processing. The calculator 1603 identifies one beacon ID included in the received notification data (S1703). For example, the calculator 1603 identifies one beacon ID in order of setting in the notification data.

The calculator 1603 identifies one management node 301 (S1705). For example, the calculator 1603 identifies one management node 301 in ascending order of management node IDs.

The determination unit 1605 executes the bloom filter determination processing (A) (S1707). In the bloom filter determination processing (A), the beacon ID identified in S1703 is applied to the bloom filter of the management node 301 identified in S1705. As a result, the determination unit 1605 determines whether or not the identified beacon ID is included in the identified management table of the management node 301. The determination unit 1605 uses the beacon ID and an ID of the identified management node 301 as arguments.

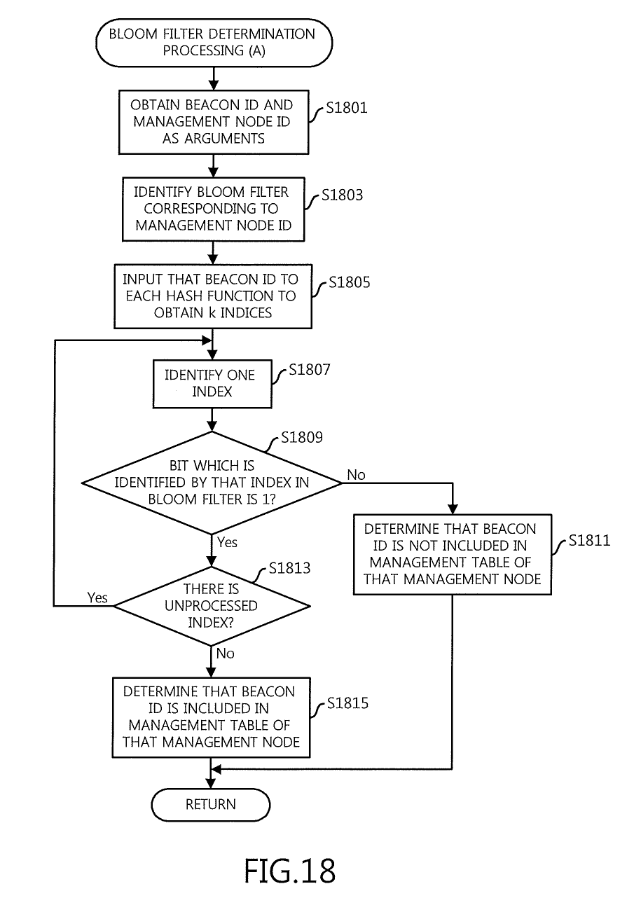

FIG. 18 illustrates a flow for the bloom filter determination processing (A). When the determination unit 1605 obtains the beacon ID and the management node ID as arguments (S1801), the determination unit 1605 identifies a bloom filter that corresponds to the management node ID (S1803). Furthermore, the determination unit 1605 inputs the beacon ID to each hash function to obtain k indices (S1805). In other words, processing by each hash calculator is executed.

The determination unit 1605 identifies one index obtained in S1805 (S1807). The determination unit 1605 determines whether or not a bit identified by the index in the bloom filter identified in S1803 is 1 (S1809).

When it is determined that the bit identified by the index in the bloom filter is not 1, the determination unit 1605 determines that the beacon ID is not included in the management table identified by the management node ID that is the argument (S1811). Then, the bloom filter determination processing (A) ends, and the processing returns to the calling-source processing.

On the other hand, when it is determined that the bit identified by the index in the bloom filter is 1, the determination unit 1605 determines whether there is an unprocessed index (S1813). When it is determined that there is an unprocessed index, the processing returns to the processing in S1807 and the aforementioned processing is repeated.

On the other hand, when it is determined that there is no unprocessed index, the determination unit 1605 determines that the beacon ID is included in the management table identified by the management node ID that is the argument (S1815). When completing the bloom filter determination processing (A), the processing returns to the calling-source processing.

Returning to the explanation of FIG. 17, the calculator 1603 branches processing depending on whether or not it is determined that the beacon ID is included in the management table of the management node 301 (S1709).

When it is determined that the beacon ID is included in the management table of the management node 301, the identification unit 1607 identifies a usage frequency of the beacon ID in the usage frequency table (S1711). The calculator 1603 adds the identified usage frequency to a total point of the management node 301 (S1713). Then, the processing shifts to S1715.

On the other hand, when it is determined that the beacon ID is not included in the management table of the management node 301, the processing shifts to S1715 without changing the total point of the management node 301.

The calculator 1603 determines whether or not there is an unprocessed management node 301 (S1715). When it is determined that there is an unprocessed management node 301, the processing returns to the processing in S1705 and the aforementioned processing is repeated.

On the other hand, when it is determined that there is no unprocessed management node 301, the calculator 1603 determines whether or not there is an unprocessed beacon ID (S1717). When it is determined that there is an unprocessed beacon ID, the processing returns to the processing in S1703, and the aforementioned processing is repeated.

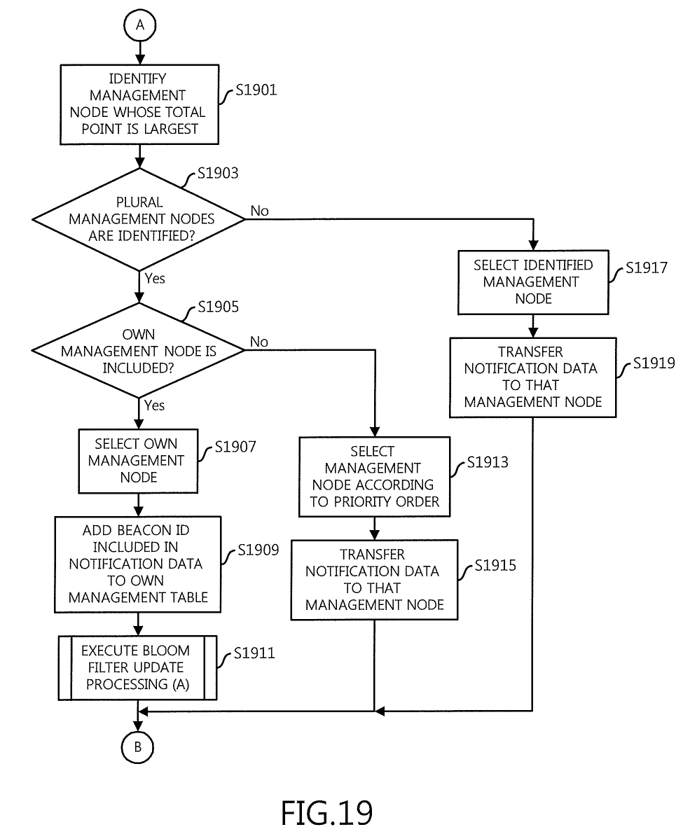

On the other hand, when it is determined that there is no unprocessed beacon ID, the processing shifts to S1901 illustrated in FIG. 19 via terminal A.

The selection unit 1609 identifies the management node 301 whose total point is the largest (S1901). At this time, the number of identified management nodes 301 is not limited to one. The selection unit 1609 determines whether or not plural management nodes 301 have been identified (S1903).

When it is determined that plural management nodes 301 have been identified, namely, when there are two or more management nodes 301 whose total points are the largest, the selection unit 1609 determines whether or not its own management node 301 is included among the identified management nodes 301 (S1905).

When it is determined that its own management node 301 is included, the selection unit 1609 selects its own management node 301 (S1907). As a result, the addition unit 1611 adds the beacon ID included in the notification data to the own management table (S1909). At this time, an accumulation node ID included in the notification data is associated with each beacon ID. Then, the update unit 1613 executes bloom filter update processing (A) (S1911). In the bloom filter update processing (A), the bloom filter that the management node 301 has is updated.

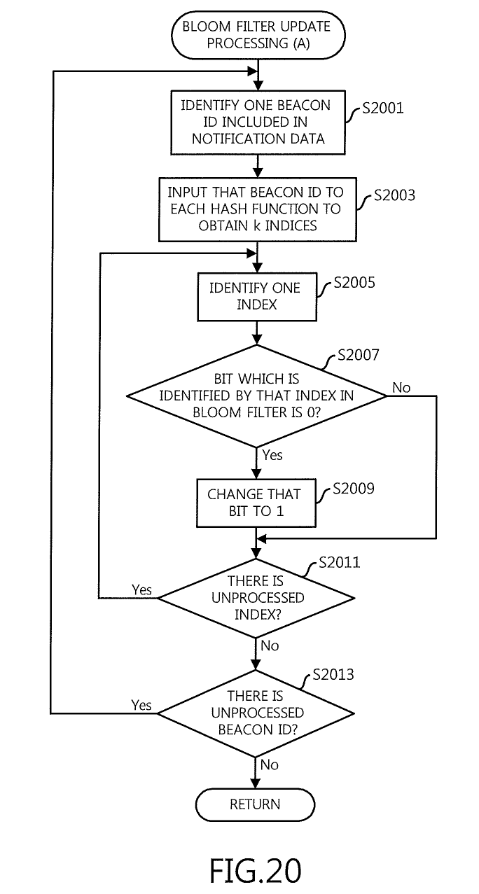

FIG. 20 illustrates a flow for the bloom filter update processing (A). The update unit 1613 identifies one beacon ID included in the notification data (S2001). The update unit 1613 identifies one beacon ID, for example, in order of setting in the notification data.

The update unit 1613 inputs the beacon ID into each hash function to obtain k indices (S2003).

The update unit 1613 identifies one index of indices obtained in S2003 (S2005) and determines whether or not the bit identified by the index is 0 in its own bloom filter (S2007). When it is determined that the bit is 0, the update unit 1613 changes the bit to 1 (S2009). On the other hand, when it is determined that the bit is not 0, in other words, when the bit is 1, the bit is not changed.

The update unit 1613 determines whether or not there is an unprocessed index (S2011). When it is determined that there is an unprocessed index, the processing returns to the processing in S2005, and the aforementioned processing is repeated.

On the other hand, when it is determined that there is no unprocessed index, the update unit 1613 determines whether or not there is an unprocessed beacon ID (S2013). When it is determined that there is an unprocessed beacon ID, the processing returns to the processing in S2001, and the aforementioned processing is repeated.

On the other hand, when it is determined that there is no unprocessed beacon ID, the bloom filter update processing (A) ends. Then, the processing returns to the calling-source processing.

Returning to the explanation of FIG. 19, when completing the bloom filter update processing (A), the processing returns to the processing of S1701 illustrated in FIG. 17 via terminal B.

On the other hand, when it is determined in S1905 of FIG. 19 that its own management node 301 is not included in the identified plural management nodes 301, the selection unit 1609 selects the management node 301 according to priority order (S1913). It is assumed that the priority order is set in advance. The transfer unit 1615 transfers the notification data received in S1701 to the selected management node 301 (S1915). Then, the processing returns to S1701 illustrated FIG. 17 via terminal B.

Moreover, when it is determined in S1903 of FIG. 19 that plural management nodes 301 are not identified, in other words, when there is one management node 301 whose total point is the largest, the selection unit 1609 selects the identified one management node 301 (S1917). The transfer unit 1615 transfers the notification data received in S1701 to the selected management node 301 (S1919). However, when selecting its own management node 301, the same processing as S1909 and S1911 is executed. Then, the processing returns to S1701 illustrated in FIG. 17 via terminal B.

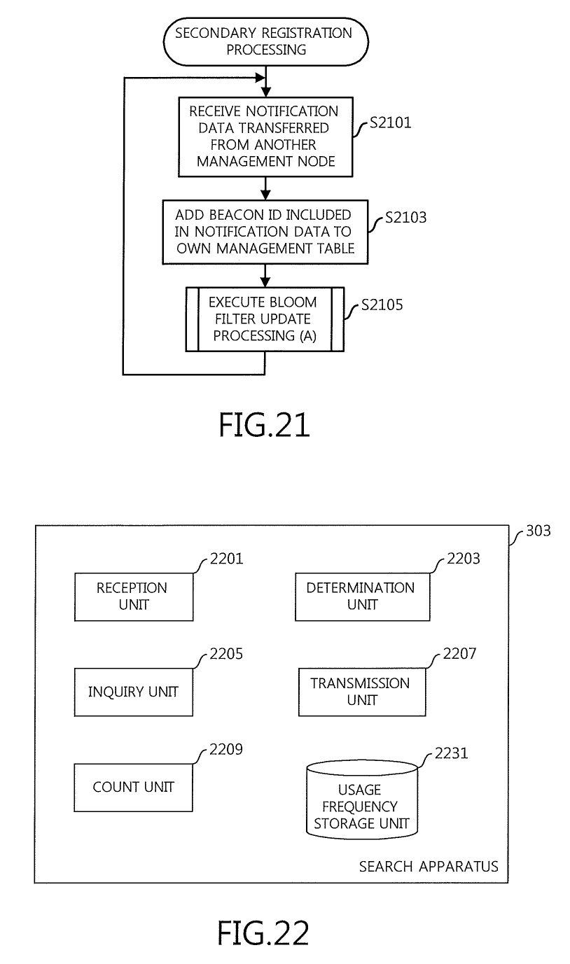

Next, processing in a case where notification data transferred from another management node 301 is accepted (hereinafter, referred to as secondary registration processing) will be explained. FIG. 21 illustrates a flow of the secondary registration processing.

When the acceptance unit 1617 accepts notification data transferred from another management node 301 (S2101), the addition unit 1611 adds a beacon ID included in the notification data to its own management table (S2103). At this time, an accumulation node ID included in the notification data is associated with each beacon ID. Then, the update unit 1613 executes the bloom filter update processing (A) (S2105).

When completing the bloom filter update processing (A), the processing returns to the processing in S2101 and the aforementioned processing is repeated. The explanation of the operation of the management node 301 ends here.

Next, operation of the search apparatus 303 will be explained. FIG. 22 illustrates an example of a module configuration of the search apparatus 303. The search apparatus 303 has a reception unit 2201, a determination unit 2203, an inquiry unit 2205, a transmission unit 2207, a count unit 2209, and a usage frequency storage unit 2231.

The reception unit 2201 receives plural types of data. The determination unit 2203 executes the bloom filter determination processing. The inquiry unit 2205 transmits an inquiry for the accumulation node 201 to the management node 301. The transmission unit 2207 transmits plural types of data. The count unit 2209 counts a usage frequency of a beacon ID.

The aforementioned reception unit 2201, determination unit 2203, inquiry unit 2205, transmission unit 2207, and count unit 2209 are realized by using hardware resources (for example, FIG. 32) and a program that causes the processor to execute processing described below.

The usage frequency storage unit 2231 stores the usage frequency table. The usage frequency storage unit 2231 is realized by using hardware resources (for example, FIG. 32).

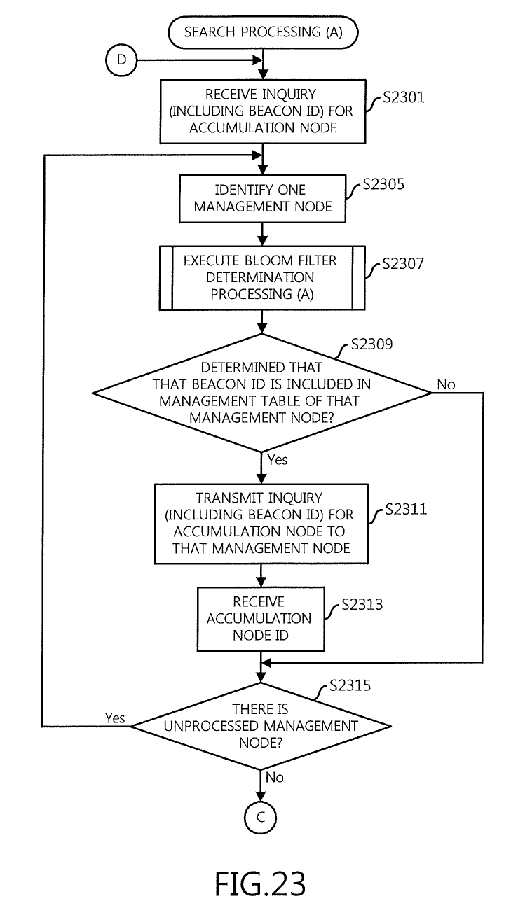

The search apparatus 303 in this embodiment executes search processing (A). FIG. 23 illustrates a flow for the search processing (A).

The reception unit 2201 receives, from the user terminal 101, an inquiry for the accumulation node 201 in which desired approach records is accumulated (S2301). The inquiry for the accumulation node 201 includes a beacon ID for designating desired approach records.

The inquiry unit 2205 identifies one management node 301 (S2305). For example, the inquiry unit 2205 identifies one management node 301 in ascending order of management node IDs.

The determination unit 2203 executes the bloom filter determination processing (A) (S2307). At this time, the determination unit 2203 uses the beacon ID included in the inquiry for the accumulation node 201 received in S2301 and an ID of the management node 301 identified in S2305 as arguments. In the repeated bloom filter determination processing (A), since processing to obtain indices from the beacon ID is redundant, the processing for the second and subsequent time may be omitted.

The inquiry unit 2205 branches processing depending on whether or not it is determined that the beacon ID is included in the management table of the management node 301 (S2309). When it is determined that the management table of the management node 301 includes the beacon ID, the transmission unit 2207 transmits an inquiry for the accumulation node 201 to the management node 301 (S2311). The inquiry for the accumulation node 201 includes the beacon ID. Then, the reception unit 2201 receives an accumulation node ID corresponding to the beacon ID from the management node 301 (S2313). The accumulation node ID is temporarily held.

On the other hand, when it is determined in S2309 that the beacon ID is not included in the management table of the management node 301, the inquiry for the accumulation node 201 is not transmitted, and the processing shifts to S2315.

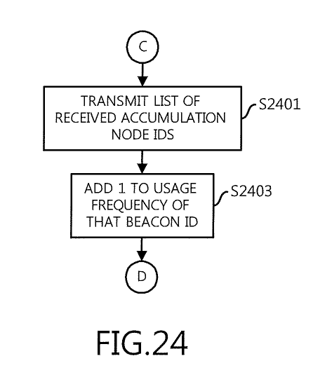

The inquiry unit 2205 determines whether or not there is an unprocessed management node 301 (S2315). When it is determined that there is an unprocessed management node 301, the processing returns to the processing in S2305 and the aforementioned processing is repeated. On the other hand, when it is determined that there is no unprocessed management node 301, the processing shifts to S2401 illustrated FIG. 24 via terminal C.

The transmission unit 2207 transmits a list of accumulation node IDs received in S2313 of FIG. 23 to the user terminal 101 that is a sender of the inquiry for the accumulation node 201 (S2401). Then, the count unit 2209 adds 1 to the usage frequency that corresponds to the beacon ID included in the inquiry for the accumulation node 201 in the usage frequency table (S2403). The processing returns to the processing of S2301 illustrated in FIG. 23 via terminal D.

Finally, an explanation for processing by the management node 301 will be complemented. When the reception unit 1601 of the management node 301 receives the inquiry for the accumulation node 201 from the search apparatus 303, the extraction unit 1619 of the management node 301 extracts, from its own management table, an accumulation node ID that corresponds to the beacon ID included in the inquiry. The transmission unit 1621 of the management node 301 transmits the accumulation node ID to the search apparatus 303.

According to this embodiment, when plural sets including a beacon ID and an accumulation node ID are collectively registered, sets relating to the same beacon ID are arranged in the same management node 301 according to a tendency of searching for them. Therefore, a load of the search processing is to be reduced while suppressing a load of the registration processing.

Moreover, access efficiency to approach records identified by a beacon ID becomes higher.

### Embodiment 2

In the aforementioned embodiment, an example in which a usage frequency of a beacon ID in the usage frequency table is counted has been explained. However, in this embodiment, an example in which a usage frequency of a beacon ID in a bloom filter is counted will be explained.

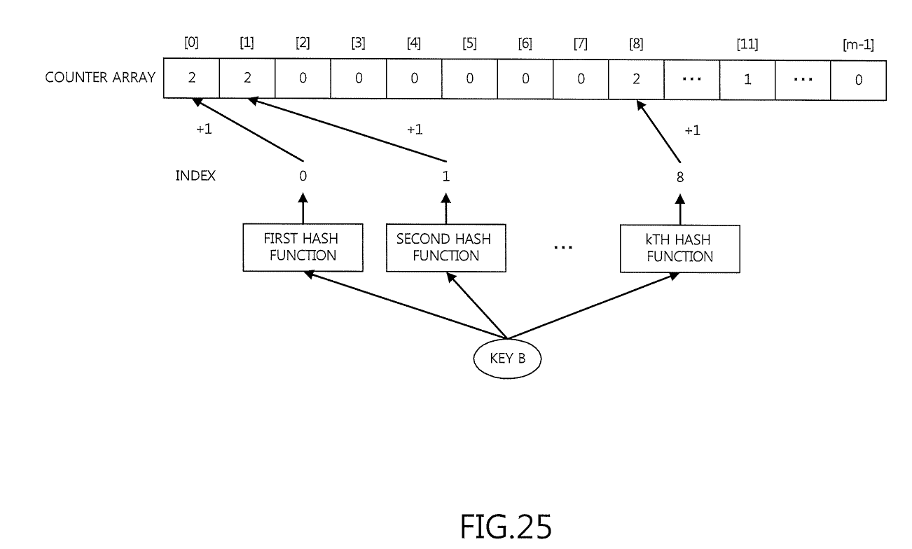

FIG. 25 illustrates an example of a bloom filter in the second embodiment. An array element in the bloom filter of this embodiment is a counter. That is, the array element has plural bits (for example, 4 bits). The counter is identified by an index. In an initial state, each counter is set to 0. When adding a new key to a set, when a value of the counter identified by the index is 0, the value of the counter is changed to 1. When the value of the counter identified by the index is 1 or more, the value of the counter is not changed.

In this embodiment, 1 is added to the value of each counter identified by the index based on a beacon ID each time the beacon ID is used as a search key for search. The example illustrated in the figure represents an aspect of update of the bloom filter in case where the key B is used for search for the first time. The first hash function to which the key B is inputted outputs an index value 0. Then, the counter [0] of the bloom filter is changed from 1 to 2. The second hash function to which the key B is inputted outputs an index value 1. Then, the counter [1] of the bloom filter is changed from 1 to 2. The k-th hash function to which the key B is inputted outputs an index value 8. Then, the counter [8] of the bloom filter is changed from 1 to 2. In this embodiment, the counter is used as a value that represents an extent to which the beacon ID has been used. When the number m of array elements and the number k of hash functions are somewhat large, a total of the counters identified by each index based on a certain beacon ID may be regarded as a usage frequency of the beacon ID.

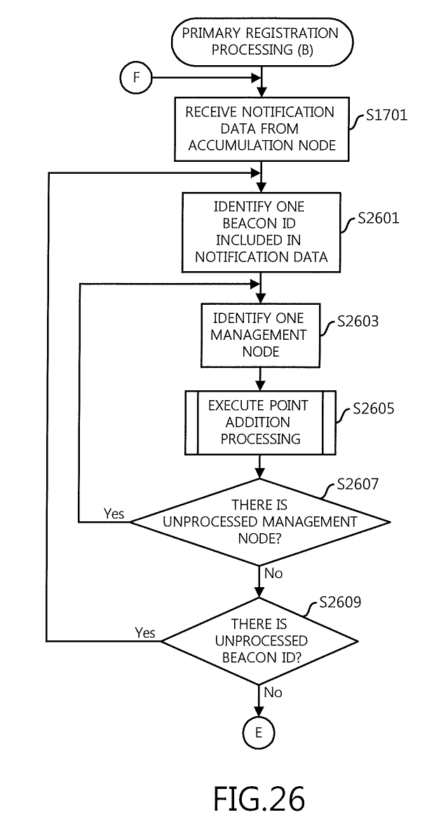

In this embodiment, the management node 301 executes primary registration processing (B) instead of the primary registration processing (A). FIG. 26 illustrates a flow for the primary registration processing (B). The processing of S1701 is the same as that of the primary registration processing (A).

The calculator 1603 identifies one beacon ID included in the received notification data (S2601). For example, the calculator 1603 identifies one beacon ID in order of setting in the notification data.

The calculator 1603 identifies one management node 301 (S2603). For example, the calculator 1603 identifies one management node 301 in ascending order of management node IDs.

The calculator 1603 executes point addition processing (S2605). In the point addition processing, a total point for each management node 301 is calculated based on a value of a counter which is an array element of a bloom filter. The calculator 1603 uses the beacon ID included in the received notification data and an ID of the management node 301 identified in S2603 as arguments.

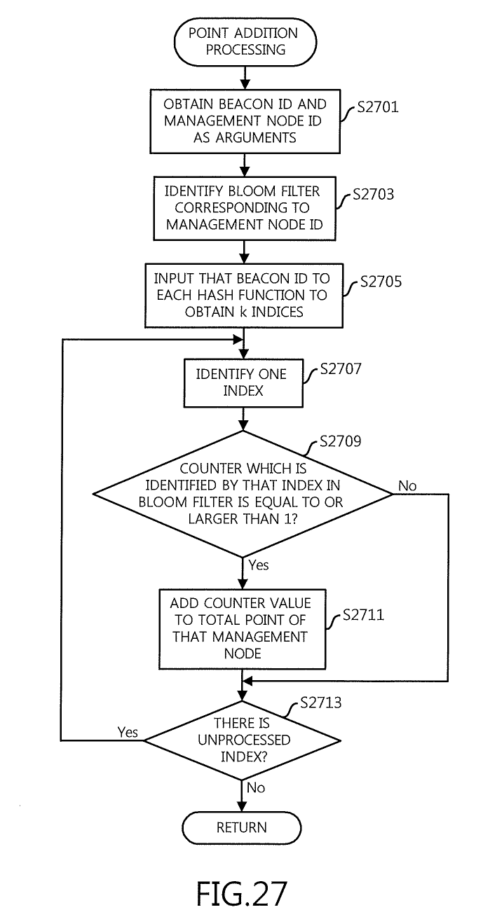

FIG. 27 illustrates a flow for the point addition processing. When the calculator 1603 obtains the beacon ID and the management node ID as arguments (S2701), the calculator 1603 identifies abloom filter that corresponds to the management node ID (S2703). Furthermore, the calculator 1603 inputs the beacon ID to each hash function to obtain k indices (S2705).

The calculator 1603 identifies one index of indices obtained in S2705 (S2707). The calculator 1603 determines whether or not a value of the counter identified by the index in the bloom filter identified in S2703 is 1 or more (S2709).

When it is determined that the value of the counter identified by the index in the bloom filter is 1 or more, the calculator 1603 adds the value of the counter to a total point of the management node 301 (S2711).

On the other hand, when it is determined that the value of the counter identified by the index in the bloom filter is not 1 or more, in other words, when the bit is 0, the calculator 1603 does not change the total point of the management node 301.

Then, the calculator 1603 determines whether or not there is an unprocessed index (S2713). When it is determined that there is an unprocessed index, the processing returns to the processing in S2707 and the aforementioned processing is repeated. On the other hand, when it is determined that there is no unprocessed index, the point addition processing ends and the processing returns to the calling-source processing.

Returning to the explanation of FIG. 26, when the calculator 1603 completed the point addition processing, the calculator 1603 determines whether or not there is an unprocessed management node 301 (S2607). When it is determined that there is an unprocessed management node 301, the processing returns to the processing in S2603, and the aforementioned processing is repeated.

On the other hand, when it is determined that there is no unprocessed management node 301, the calculator 1603 determines whether or not there is an unprocessed beacon ID (S2609). When it is determined that there is an unprocessed beacon ID, the processing returns to the processing in S2601, and the aforementioned processing is repeated.

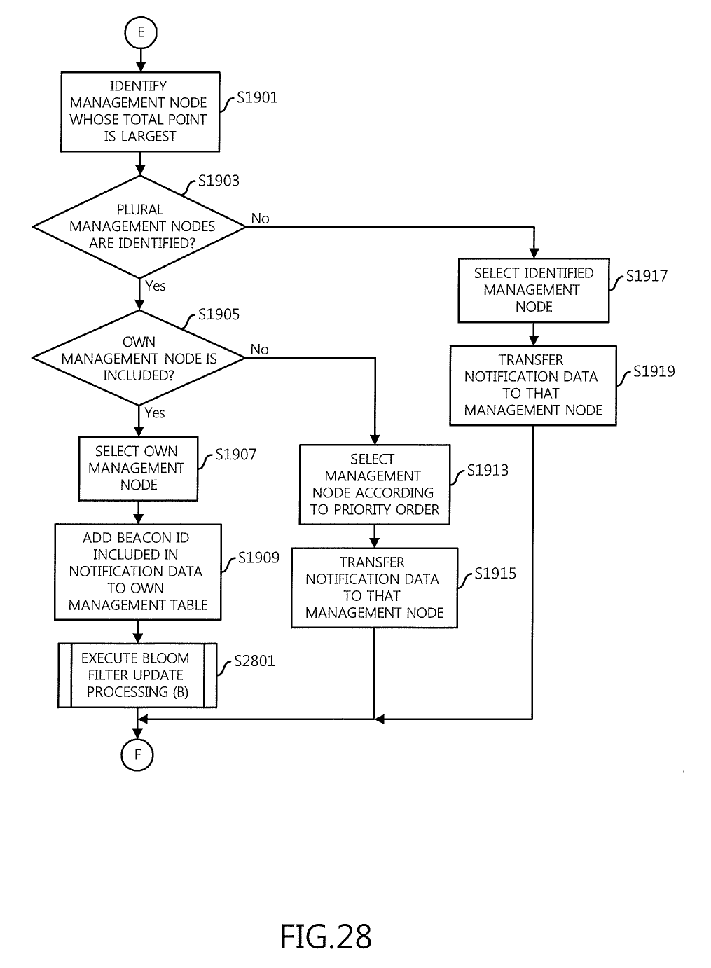

On the other hand, when it is determined that there is no unprocessed beacon ID, the processing shifts to S1901 illustrated in FIG. 28 via terminal E.

Shifting to the explanation for FIG. 28, the processing of S1901 to S1909 is the same as that of the primary registration processing (A).

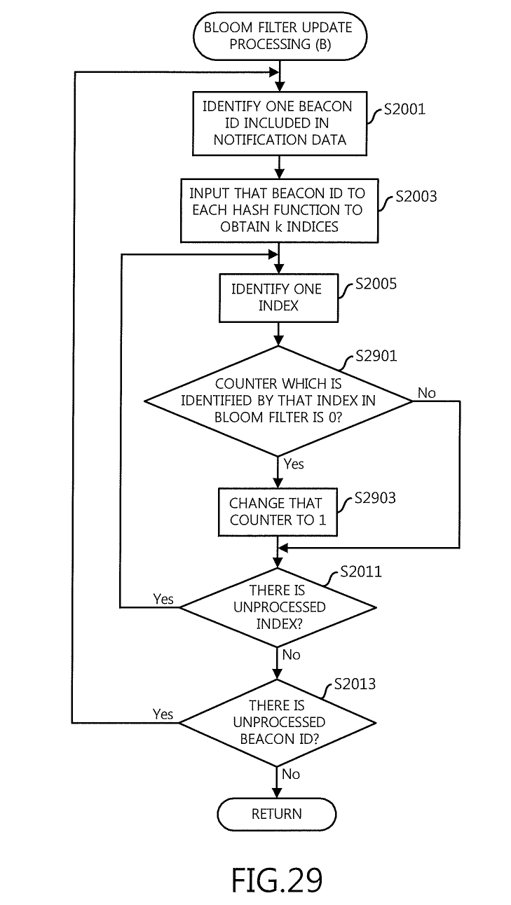

The update unit 1613 executes bloom filter update processing (B) (S2801). FIG. 29 illustrates a flow for the bloom filter update processing (B). The processing of S2001 to S2005 is the same as that of the bloom filter update processing (A).

The update unit 1613 determines whether or not a value of the counter identified by the index in its own bloom filter is 0 (S2901). When it is determined that the value of the counter is 0, the update unit 1613 changes the value of the counter to 1 (S2903). On the other hand, when it is determined that the value of the counter is not 0, that is, when the value of the counter is 1 or more, the update unit 1613 does not change the value of the counter.

The processing in S2011 and S2013 is the same as that of the bloom filter update processing (A). When completing the bloom filter update processing (B), the processing returns to the calling-source processing.

Returning to the explanation of FIG. 28, when completing the bloom filter update processing (B) and returning, the processing returns to the processing of S1701 illustrated in FIG. 26 via terminal F.

Steps S1913 to S1919 are the same as those in the primary registration processing (A). When the processing of S1915 is completed, the processing returns to the processing of S1701 illustrated in FIG. 26 via terminal F. Even when the processing of S1919 is completed, the processing returns to S1701 illustrated in FIG. 26 through terminal F.

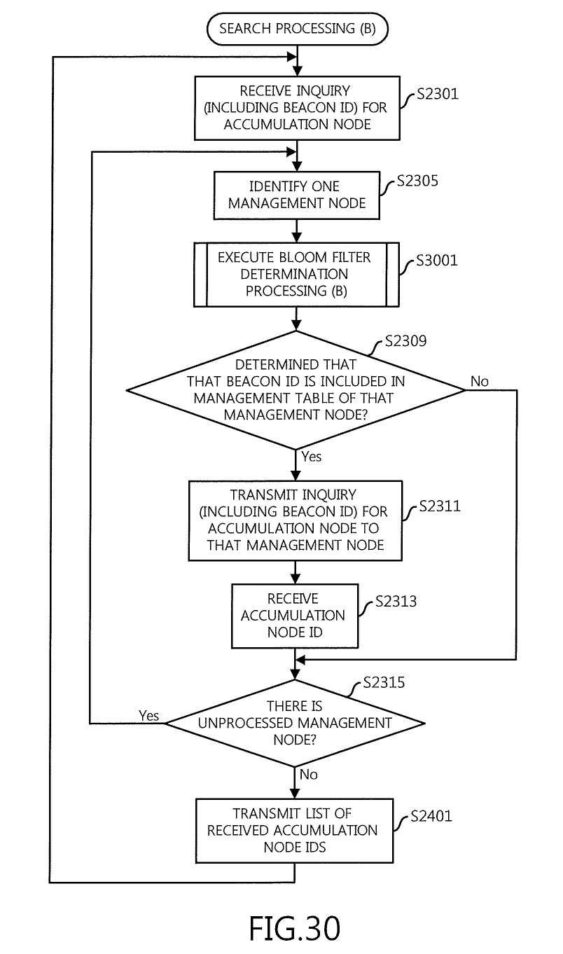

Moreover, the search apparatus 303 in this embodiment executes search processing (B) instead of the search processing (A). FIG. 30 illustrates a flow for the search processing (B). The processing in S2301 and S2305 is the same as that of the search processing (A).

When the determination unit 2203 identifies one management node 301 in S2305, the determination unit 2203 executes the bloom filter determination processing (B) (S3001). At this time, the determination unit 2203 uses the beacon ID included in the inquiry for accumulation node 201 received in S2301 of FIG. 30 and an ID of the management node 301 identified in S2305 of FIG. 30 as arguments.

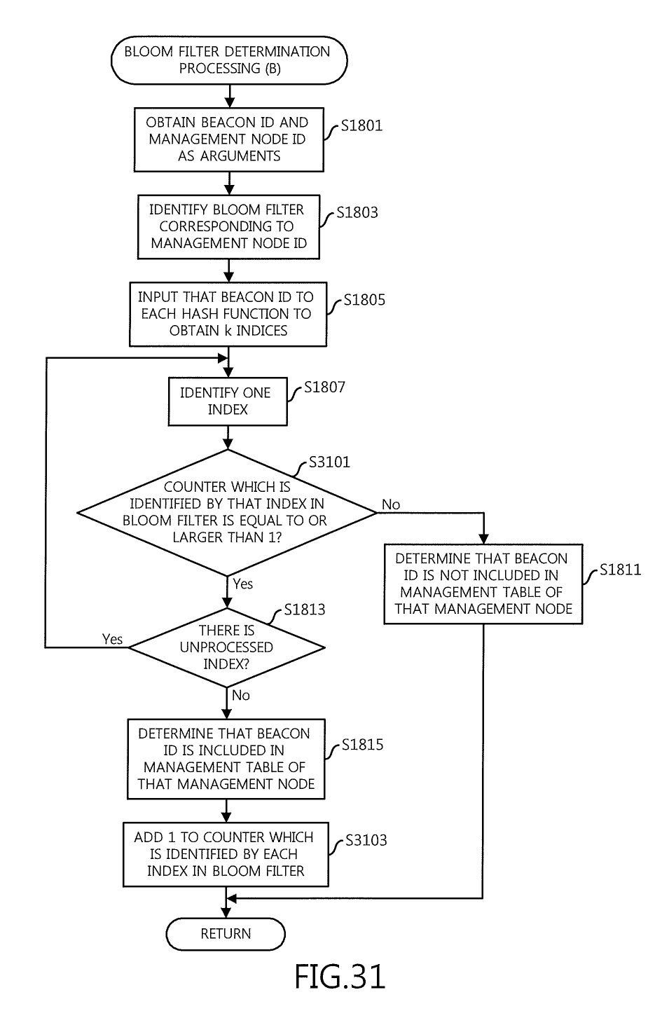

FIG. 31 illustrates a flow for the bloom filter determination processing (B). The processing of S1801 to S1807 is the same as that of the bloom filter determination processing (A).

When one index is identified in S1807, the determination unit 2203 determines whether or not a value of the counter identified by the index in the bloom filter is 1 or more (S3101). When it is determined that the value of the counter identified by the index in the bloom filter is not 1 or more, that is, when the value of the counter is 0, the determination unit 2203 determines that the beacon ID is not included in the management table identified by the management node ID that is the argument (S1811). Then, the bloom filter determination processing (B) ends and the processing returns to the calling-source processing.

On the other hand, when it is determined that the value of the counter identified by the index is 1 or more in the bloom filter, the determination unit 2203 determines whether or not there is an unprocessed index (S1813). The processing of S1813 and S1815 are the same as that of the bloom filter determination processing (A).

In S1815, when determining that the management table identified by the management node ID that is the argument includes the beacon ID, the determination unit 2203 adds 1 to the counter identified by each index obtained in S1805 in the bloom filter (S3103). Then, the bloom filter determination processing (B) ends and the processing returns to the calling-source processing.

Returning to the explanation of FIG. 30, the processing of S2309 to S2401 is the same as that of the search processing (A).

According to this embodiment, because it is not necessary to provide a counter other than the bloom filter, it becomes easier to manage a frequency of use of a key.

Since data size of the counter that is an array element is arbitrary, the data size of the counter may be set as the system information so that a configuration of the bloom filter is changed according to the set data size.

Moreover, the data size of each counter in one bloom filter may not be the same.

Although the embodiments of this invention were explained above, this invention is not limited to those. For example, the aforementioned functional block configuration does not always correspond to actual program module configuration.

Moreover, the aforementioned configuration of each storage area is a mere example, and may be changed. Furthermore, as for the processing flow, as long as the processing results do not change, the turns of the steps may be exchanged or the steps may be executed in parallel.

In addition, the aforementioned accumulation node 201, management node 301 and search apparatus 303 are computer devices as illustrated in FIG. 32. That is, a memory 2501, a CPU 2503 (central processing unit), a HOD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 32. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this invention, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer device as stated above, the hardware such as the CPU 2503 and the memory 2501, the OS and the application programs systematically cooperate with each other, so that various functions as described above in details are realized.

The aforementioned embodiments are summarized as follows:

A data management method relating to embodiments includes: (A) identifying, for each key included in a plurality of sets each of which includes a key and a value, a frequency that the key was used for search, when the plurality of sets is to be added to one of a plurality of storage units that dispersedly store sets each of which includes a key and a value; (B) weighting each key included in the plurality of sets by the frequency identified for the key to calculate, for each of the plurality of storage units, an inclusion degree for keys included in the plurality of sets; and (C) selecting a storage unit to which the plurality of sets is to be added based on the calculated inclusion rates.

In this way, it is possible to arrange data that includes plural keys so as to improve efficiency of search.

Furthermore, the data management method may further include: counting the frequency by using array elements of a bloom filter, wherein a number of the array elements for mapping keys is 3 or more and the bloom filter is provided for each of the plurality of storage units.

In this way, it is not necessary to provide a counter other than the bloom filter, and it becomes easier to manage the frequency a key was used.

Furthermore, the value may represent a storage location of information associated with the key.

In this way, efficiency of access to information associated with a key becomes improved.

Incidentally, it is possible to create a program causing a computer to execute the aforementioned processing, and such a program is stored in a computer readable storage medium or storage device such as a flexible disk, CD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. Anon-transitory computer-readable storage medium storing a program that causes a computer to execute a process, the process comprising:
identifying, for each key included in a plurality of sets each of which includes a key and a value, a frequency that the key was used for search, when the plurality of sets is to be added to one of a plurality of storage units that dispersedly store sets each of which includes a key and a value;
weighting each key included in the plurality of sets by the frequency identified for the key to calculate, for each of the plurality of storage units, an inclusion degree for keys included in the plurality of sets; and
selecting a storage unit to which the plurality of sets is to be added based on the calculated inclusion rates.

2. The non-transitory computer-readable storage medium as set forth in claim 1, wherein the process further comprises counting the frequency by using array elements of a bloom filter, wherein a number of the array elements for mapping keys is 3 or more and the bloom filter is provided for each of the plurality of storage units.

3. The non-transitory computer-readable storage medium as set forth in claim 1, wherein the value represents a storage location of information associated with the key.

4. A data management method, comprising:
identifying, by using a computer and for each key included in a plurality of sets each of which includes a key and a value, a frequency that the key was used for search, when the plurality of sets is to be added to one of a plurality of storage units that dispersedly store sets each of which includes a key and a value;
weighting, by using the computer, each key included in the plurality of sets by the frequency identified for the key to calculate, for each of the plurality of storage units, an inclusion degree for keys included in the plurality of sets; and
selecting, by using the computer, a storage unit to which the plurality of sets is to be added based on the calculated inclusion rates.

5. A data management apparatus, comprising:
a memory; and
a processor coupled to the memory and configured to:
identify, for each key included in a plurality of sets each of which includes a key and a value, a frequency that the key was used for search, when the plurality of sets is to be added to one of a plurality of storage units that dispersedly store sets each of which includes a key and a value;
weight each key included in the plurality of sets by the frequency identified for the key to calculate, for each of the plurality of storage units, an inclusion degree for keys included in the plurality of sets; and
select a storage unit to which the plurality of sets is to be added based on the calculated inclusion rates.
